(19) United States
(12) Patent Application Publication
(10) Pub. No.: US 2019/0382610 A1
(43) Pub. Date: Dec. 19, 2019

(54) KIT AND COMPOSITION FOR REFLECTIVE PARTICLES

(71) Applicant: CRAYOLA LLC, Easton, PA (US)

(72) Inventors: Matt Durant, San Clemente, CA (US); Keith John Allison, Blandon, PA (US); Alexandra Catherine Looney, Easton, PA (US); Joseph Thomas Moll, Bethlehem, PA (US); Steve Delacy, Santa Ana, CA (US); Greg Leong, Irvine, CA (US); Jim McCafferty, San Clemente, CA (US)

(21) Appl. No.: 16/444,889

(22) Filed: Jun. 18, 2019

Related U.S. Application Data
(60) Provisional application No. 62/686,401, filed on Jun. 18, 2018.

(51) Int. Cl. C09D 103/02; B41F 15/34

(52) U.S. Cl. CPC C09D 103/02; B41F 15/34

(57) ABSTRACT

Embodiments herein disclose a composition including reflective particles and a kit that includes the composition. In embodiments, the composition includes a synthetic polymer, modeling compound, and reflective particles. In some embodiments, the kit includes the composition and a surface or object to which the composition may be applied. Embodiments herein further disclose a crush-resistant container for storage of the composition.

### CROSS-REFERENCE TO RELATED APPLICATIONS

This application entitled “Kit and Composition for Reflective Particles” is a nonprovisional application that claims the benefit of and priority to provisional U.S. Application No. 62/686,401, filed on 18 Jun. 2018 and entitled “Kit and Composition for Glitter,” the entirety of which is incorporated by reference herein.

### BACKGROUND

Reflective particles, such as glitter, are a medium that is notoriously difficult to control, contain, and clean up. Because of these difficulties, the shiny, tiny, light-weight, and often airborne particles manage to inconceivably migrate from an art project, for example, to clothing, skin, rugs, furniture, pets, cabinets, and all household surfaces. Once glitter is unleashed from its container, it cannot be eradicated from a household nor will it be prevented from migrating to new and unwanted locations both in and out of the home (e.g., finding glitter in unexpected places and even years later). Accordingly, controlling the application of loose glitter and/or containing loose glitter spills is an exercise in futility. Yet, glitter remains an extremely popular medium because it provides an exciting, light-catching appearance that cannot be replicated by other materials, thereby ensuring its continued use and corresponding frustration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims as supported by the Specification, including the Detailed Description.

In brief and at a high level, this disclosure describes, among other things, a composition and kits comprising the composition. The composition comprising reflective particles provides the look of pure glitter in a mess-free, dough-like material that may be adhered to surfaces and objects. Moreover, the composition may be applied to and removed from a surface after application multiple times, for example, while the reflective particles remain held within the composition. In this way, the composition can be used as a mess-free and non-flaking replacement for the messy, conventional means of applying an adhesive, such as a glue, to a surface, pouring loose glitter onto the exposed, adhesive portions of the surface for permanent affixation (i.e., glitter cannot be removed once the adhesive is bonded to the glitter, such as when glue cures or dries), shaking off the loose glitter that does not adhere to the adhesive portions of the surface, and attempting to contain the loose glitter throughout the process.

This disclosure further describes, among other things, a container or packaging for storing discrete volumes of the composition. The container provides a plurality of wells that protect against crushing of the discrete volumes of the composition as stored in a desired shape or form within the wells.

### BRIEF DESCRIPTION OF THE DRAWINGS

Embodiments are described in detail below with reference to the attached drawings figures, wherein:

FIG. 1 is a table of example value ranges for components of the composition in accordance with an embodiment;

FIGS. 2-4 depict an example of applying force to a defined volume of the composition in order to deform the defined volume of the composition in accordance with an embodiment;

FIG. 5 is a perspective view of an example of a defined volume of the composition as shaped into a form in accordance with an embodiment;

FIG. 6 depicts a perspective view of an example tool in accordance with an embodiment;

FIG. 7 depicts a perspective view of an example tool in accordance with another embodiment;

FIG. 8 depicts a perspective view of an example of a container for storage of defined volumes of the composition in accordance with an embodiment;

FIG. 9 depicts another perspective view of an example of a container for storage of defined volumes of the composition in accordance with an embodiment;

FIG. 10 depicts a cross-sectional view of a portion of the container of FIG. 9 in accordance with an embodiment;

FIG. 11 depicts a bottom-up view of the container of FIG. 9 in accordance with an embodiment;

FIG. 12 depicts a cross-sectional view of the container of FIG. 9 in accordance with an embodiment;

FIG. 13 is an exemplary kit in accordance with an embodiment;

FIG. 14 is an exemplary kit in accordance with an embodiment;

FIG. 15 is an exemplary kit in accordance with an embodiment; and

FIG. 16 is an exemplary kit in accordance with an embodiment.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different components or combinations of components similar to the ones described in this document, in conjunction with other present or future technologies.

Embodiments of the present invention provide a composition, a container for storage of the composition, and a kit having the composition and an object. The composition generally includes a mixture of one or more compounds or components that form a dough-like base into which reflective particles are added. In embodiments, the composition is a cross-linked, high-viscosity liquid that exhibits reduced or no flow when in a steady-state, e.g., dough-like consistency and texture. In some embodiments, the composition comprises a synthetic polymer, a modeling compound, and reflective particles in specific ratios and value ranges discussed hereinafter, which provide the composition with superior shape retention, mold-ability, and spreading quality. Alternatively, in some embodiments, the composition comprises a synthetic polymer, a starch or a non-starch based modeling compound (e.g., silicone), and reflective particles in specific ratios and value ranges discussed hereinafter, which provide the composition with superior shape retention, mold-ability, and spreading quality. Additionally, the ratios and value ranges of the one or more components in the composition provide the composition with a level of opacity and a degree of reflective particles that imbue the composition with the appearance of “pure glitter,” while providing containment of the reflective particles within the composition to reduce “fall-out.”

In this manner, the composition has the appearance of pure glitter while the composition exhibits an adhesion strength that prevents or reduces fall-out of reflective particles from the composition, thus providing a mess-free medium. However, the adhesion strength is balanced through the ratios and value ranges of the one or more components in the composition so that the composition is moldable and has shape retention like a dough. Further, the adhesion strength is balanced through the ratios and value ranges of the one or more components in the composition so that the composition may be physically applied to an object or surface using force or pressure in order to create the appearance of being coated in glitter in those areas of the object or surface to which the composition is physically applied. In some aspects, once the composition is applied to a desired substrate having particular surface characteristics, the composition may be allowed to “cure,” or dry on the substrate, with such curing including a bonding of at least a portion of the composition to the surface. Upon curing, the dried composition maintains its stabilized properties, in some aspects, and retains the glitter bound within the composition on the substrate. Additionally, unlike conventional methods for applying loose glitter, the adhesion strength of the composition is balanced such that the composition can be applied to a surface and be easily removed from that surface after application, for example, without leaving behind a mess of reflective particles. Accordingly, embodiments of the compound may be applied to a desired substrate to adhere glitter within the compound to the surface. While the compound is still moist, the glitter may be removed from the surface, still retained within the compound, while in other aspects, the compound may be allowed to dry on the surface with the glitter remaining attached to the surface. In other words, whether the compound has been freshly applied to a surface, or has been drying on a surface over time, in some embodiments, the glitter particles within the compound remain retained within the compound whether the compound is in a moistened, repositionable state, or in a dried and stationary state on the applied surface. In some embodiments, regardless of the temporary or permanent status of the compound with respect to a substrate, the adhesive properties of the compound continue to retain the glitter particles in a desired location.

In this way, the composition provides a mess-free and non-flaking replacement for the untidy, conventional means of applying runny (i.e., a low viscosity, high flow rate liquid) adhesive (e.g., white glue) to a surface, pouring loose glitter onto the uncured white glue for permanent affixation (i.e., glitter cannot be removed once white glue cures or dries), shaking off the loose glitter that does not adhere to the white glue once the white glue has cured, and attempting to recapture any and all loose glitter from this process. In conventional methods, loose glitter is difficult to control and difficult to clean up. Because the loose glitter particles are small and lightweight, they are easily rendered airborne with the smallest disturbance and attach themselves to every surface using static electricity. As such, loose glitter is notoriously difficult to control and contain. However, embodiments herein discuss a composition that exhibits the desired look of pure glitter while the composition also controls and contains reflective particles within the composition, avoiding messes.

It will be understood from this Description that the composition may include other component(s) in addition to reflective particles, the modeling compound (e.g., starch or silicone based), and synthetic polymer. The reflective particles may be mixed into and held or otherwise suspended within a base comprising the modeling compound and synthetic polymer. Because the reflective particles are mixed into the base comprising the modeling compound and synthetic polymer, the reflective particles are controlled within the composition, i.e., the reflective particles are not free or loose. In this way, the composition enables controlled application of the composition with the reflective particles. Additionally, because the reflective particles are held in the composition, the composition provides a mess-free application of reflective particles, and reduces or eliminates clean-up of the reflective particles. The high percentage of reflective particles in the compound provides the look of pure reflective particles without the mess associated with loose reflective particles. As used herein, “the appearance of pure reflective particles” refers to the visible effect that a surface is completely or nearly completely coated in reflective particles.

In some embodiments, the composition may have a viscosity and consistency that is similar to putty, clay, dough, or other deformable and re-formable modeling compound. As such, in an embodiment, the composition may be deformed by application of force or pressure. The composition may conform to surfaces when force or pressure is applied to the composition placed on a surface, for example. The composition may be adhered to a surface by using force or pressure to the composition to increase contact of the composition with areas of the surface, in an embodiment. By using force to place the composition in physical contact with the surface or object, the composition described herein is applied to the surface or object and creates an appearance that individual particles of glitter are positioned adjacent additional particles of glitter to provide a consistent surface treatment of glitter. In other words, the composition may be used to create an appearance of the surface or object being completely or nearly completely coated with reflective particles. Notably, the adhesion characteristics and increased viscosity of the composition is such that the reflective particles adhered to the surrounding composition, even when force or pressure is applied, such that the reflective particles are not free or loose, and are resistant to falling out from the composition. The consistency of the composition is such that the reflective particles are retained in the composition. Accordingly, the composition reduces the ability of the reflective particles from falling out (e.g., flaking out) of the composition.

### Composition

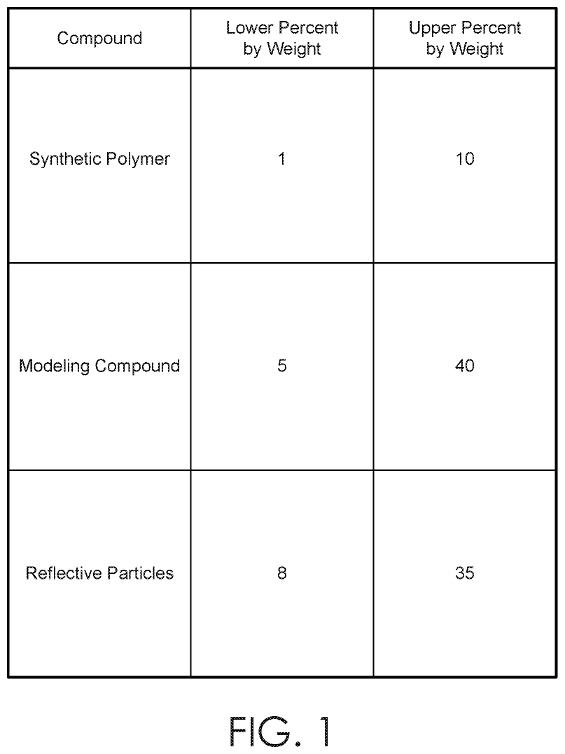

A composition including reflective particles is described herein. In an embodiment, the composition comprises an adhesive component, a modeling compound (e.g., a putty, clay, dough, or other buildable compound), and a plurality of reflective particles. In one embodiment, the composition comprises a synthetic polymer, a modeling compound, and a plurality of reflective particles. In some embodiments, the modeling compound may comprise one or more of a starch, a starch substitute, or non-starch component that provides a dough-like buildability. In further aspects, the composition comprises a synthetic polymer, a modeling compound that comprises a starch or a starch substitute or a non-starch, and a plurality of reflective particles. In another embodiment, the composition comprises a synthetic polymer, a modeling compound that comprises a starch, and a plurality of reflective particles. As shown in FIG. 1, a table of example values and value ranges for the components forming the composition are shown. In the example embodiment of FIG. 1, the composition comprises a water-soluble synthetic polymer, a modeling compound comprising a starch, and a plurality of reflective particles.

In embodiments, the composition includes a synthetic polymer. In one embodiment, the synthetic polymer comprises an adhesive. Additionally, the synthetic polymer may be water-soluble, in some embodiments. Examples of a water-soluble synthetic polymer include polymers derived from vinyl monomers. The water-soluble synthetic polymer may be a polyvinyl ester, in some embodiments. In one embodiment, the water-soluble synthetic polymer comprises polyvinyl acetate. In another embodiment, the water-soluble synthetic polymer comprises polyvinyl alcohol. In some embodiments, the water-soluble synthetic polymer includes a mixture of polyvinyl acetate and polyvinyl alcohol. Alternatively, the synthetic polymer may not be water-soluble or may be only partially water-soluble, in some embodiments.

In embodiments, the composition comprises from about 1 to about 10 percent by weight synthetic polymer. As used herein, the term “about” is used to designate that the value indicated includes approximately a range ±0.75 percent above or below the value, unless otherwise specified. In another embodiment, the composition comprises from about 1 to about 8 percent, by weight, synthetic polymer. In further embodiments, the composition comprises from about 1.5 to about 5 percent by weight synthetic polymer. In some embodiments, the composition comprises from about 2 to about 3.75 percent by weight synthetic polymer.

The composition further comprises a modeling compound. In one embodiment, the modeling compound comprises a starch and/or a starch substitute, in embodiments. Alternatively or additionally, the modeling compound may comprise a non-starch compound such as silicone. In various embodiments, the modeling compound may comprise one or more of a starch, a silicone, a ceramic clay, an oil-based clay, a polymer clay, a paper clay, a salt-dough, or other malleable compounds with buildability. The modeling compound may include one or more components, such as starch and/or silicone, or a combination thereof. Generally, the term “starch” refers to a polymeric carbohydrate having a plurality of glucose units sharing glycosidic bonds. In an embodiment, starch comprises amylose (i.e., a helical polysaccharide of glucose) and amylopectin (i.e., a branched polysaccharide of glucose) molecules. Starch may be sourced from plants such as potatoes, wheat, maize, rice, and cassava, for example. In one embodiment, starch comprises a grain-based starch, such as wheat flour, spelt flour, rice flour, or barley flour. In another embodiment, starch comprises a non-grain based flour, such as potato flour, arrowroot powder, or cassava flour. Alternatively, an example of a starch substitute is glycogen or a molecule that is similarly configured to glycogen. In some embodiments, the starch comprises starch that is solubilized in a volume of water.

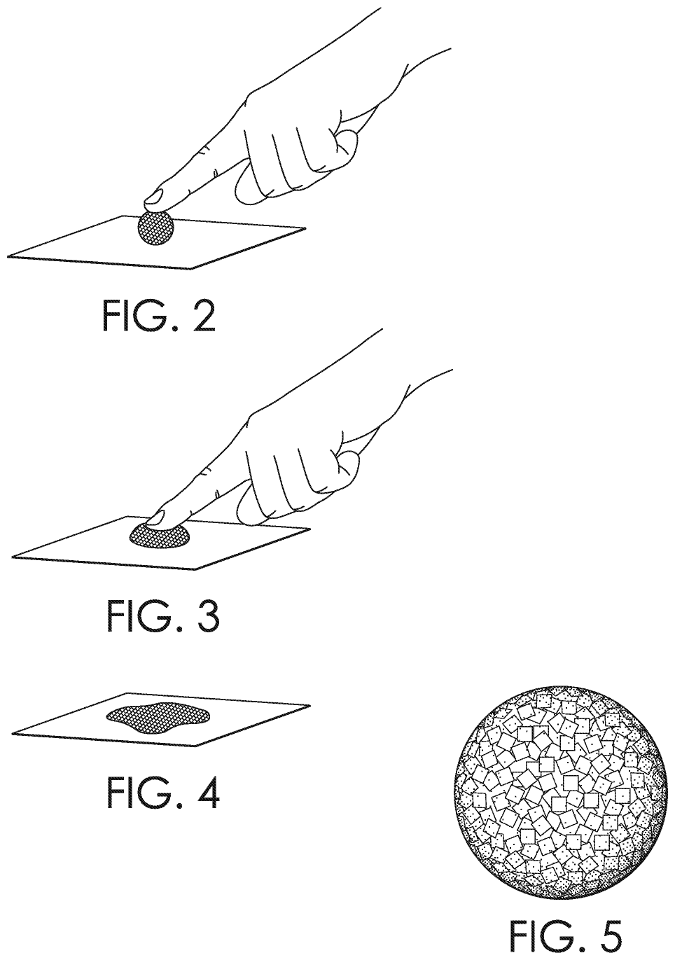

In various embodiments, the composition comprises from about 5 to about 40 percent by weight modeling compound. In further embodiments, the composition comprises from about 10 to about 30 percent by weight modeling compound. The composition comprises from about 15 to about 25 percent by weight modeling compound, in some embodiments. In further embodiments, the composition comprises from about 17 to about 22 percent by weight modeling compound. In some embodiments, the composition comprises from about 18 to about 21 percent by weight modeling compound. The values and value ranges of the modeling compound and/or starch or starch substitute percent by weight imbues the composition with a dough-like consistency, in various embodiments. A dough-like consistency is desirable because such a consistency allows the composition to be kneaded, molded into shapes, smoothly rolled out with reduced tearing, cut into shapes, and yet the shape is retained based on the modeling compound and/or starch content. As shown in FIGS. 2-4, the dough-like consistency allows a user to apply force or pressure to a discrete volume of the composition in order to increase contact of the surface area of the volume of composition and deform the composition. Therefore, the defined volume of the composition is deformed in order to spread the composition over a surface as shown in the example of FIG. 4.

In embodiments, the composition further comprises a plurality of reflective particles. Generally, the term reflective particles refers to glitter. Though the term “reflective” is used herein for simplicity, it will be understood that “reflective” includes non-reflective characteristics or other visual effects. For example, reflective particles may include glitter (i.e., a metallic or a chrome-like finish). The reflective particles may exhibit special effects characteristics such as glow-in-the-dark, a degree of transparency, iridescence, opalescence, holographic, heat-responsive color changes, and/or light-responsive color changes, in various embodiments. In another example, the reflective particles may exhibit a first color from one viewing angle and a second, different color from a second, different viewing angle, to create a “duo-chrome” or color-flash effect.

In embodiments, the composition may comprise reflective particles consisting of one color. In some embodiments, the composition may comprise reflective particles of more than one color. The composition may comprise reflective particles in combinations of color(s) and/or special effect(s), in various embodiments. In embodiments, the color of the reflective particles may be the same or in the same color family as the color of the remaining portion of the composition (e.g., based on pigment(s) or dye(s) in the composition). As discussed above, the composition may include one or more pigments that increase the opacity of the composition. In one example, the overall composition may be purple, and include purple glitter. Together, the increased opacity of the composition resulting from the inclusion of one or more pigments in combination with the reflective particles content in the range discussed above provide the composition with the desired appearance of pure glitter. Alternatively, the color of the reflective particles may be different than the color of the remaining portion(s) of the composition. For example, the overall composition may be green in color while the reflective particles are purple in color. In yet a further example, the overall composition may be red, and include both gold and orange glitter. Accordingly, it will be understood that the combination of pigments and the color or special effect provided by the reflective particles found in the final composition may vary. In further embodiments, the other components of the composition may be colorless or nearly colorless, such that the color of the reflective particles provides the overall visible color of the composition. For example, a transparent or at least somewhat transparent base of the composition may be formulated in a manner that refracts light, which may magnify and visibly increase the reflectivity of the reflective particles in the composition (e.g., the composition may have a “wet look” appearance where the glitter exhibits visibly increased shine, depth, and color saturation).

The dimensions or size of the individual reflective particles may be macro (e.g., approximately 0.250 inches or less), chunky (e.g., approximately 0.040 inches or less), standard (e.g., approximately 0.080 inches or less), fine (e.g., approximately 0.015 inches or less), extra-fine (e.g., approximately 0.008 inches or less), super-fine (e.g., approximately 0.006 inches or less), and/or a mix thereof, in various embodiments. Further, the shape of the individual reflective particles may be any shape (e.g., hexagonal, octagonal, square, round, circular, five-pointed star, asymmetrical), and may comprise more than one shape. It will be thus understood that the shape and size of the reflective particles shown in the figures herein are non-limiting.

In an embodiment, the composition comprises at least about 8 percent, by weight, of reflective particles. In another embodiment, the composition comprises at least about 12 percent, by weight, of reflective particles. In one embodiment, the composition comprises at least about 15 percent, by weight, of reflective particles. In some embodiments, the composition comprises at least about 18 percent, by weight, of reflective particles. In further embodiments, the composition comprises at least about 20 percent, by weight, of reflective particles. In another embodiment, the composition comprises at least about 30 percent, by weight, of reflective particles. In yet another embodiment, the composition may comprise a range of at least about 15 to about 35 percent by weight of reflective particles. In an embodiment, the composition comprises a range of at least about 16 to about 22 percent by weight of reflective particles. The percent by weight or the range of percent by weight of the reflective particles in the composition provides the composition with the appearance of “pure glitter” while maintaining the composition's ability to prevent or reduce the fall-out of reflective particles from the composition, thus providing a mess-free medium. Accordingly, when the composition is applied to an object or surface, the object or surface gains the appearance of being “coated in glitter” in areas to which the composition is applied from the percent by weight of reflective particles in the composition. For example, the defined volume of the composition that is deformed and applied over the surface in FIG. 5 has the appearance of pure glitter.

Further, the composition may be applied to and removed from a surface after application multiple times, for example, generally without leaving behind any or much of the reflective particles because the reflective particles are held within the composition. In this way, the composition can be used as a mess-free and non-flaking replacement for the messy, conventional means of applying runny white glue to a surface, pouring loose glitter onto the white glue for permanent affixation (i.e., glitter cannot be removed once white glue cures or dries), shaking off the loose glitter that does not adhere to the white glue, and attempting to contain the loose glitter throughout the process.

Continuing, in embodiments, the ratio of the percent by weight of the synthetic polymer relative to the percent by weight of the modeling compound facilitates an even distribution of the reflective particles in the composition. Additionally, the ratio is such that the reflective particles do not “settle” to the bottom of the composition based on gravity, and such that the reflective particles do not aggregate together to form “clumps” in the composition. Further still, the ratio of the percent by weight of the synthetic polymer relative to the modeling compound facilitates retaining of the reflective particles in the composition. Because the composition holds the reflective particles in the composition, flaking or fall-out of the reflective particles is reduced even after the composition is applied to an object or surface. For example, the composition may comprise from about 1 to about 5 percent, by weight, the synthetic polymer and from about 15 to about 30 percent, by weight, the modeling compound. In another example, the composition may comprise from about 3 to about 4 percent, by weight, the synthetic polymer and from about 17 to about 22 percent, by weight, the modeling compound. In various embodiments, the composition comprises a ratio between 1:6 and 1:40 of the synthetic polymer relative to the modeling compound. In some embodiments, the composition comprises a ratio between 1:6 and 1:20 of the synthetic polymer relative to the modeling compound. In such embodiments, this range of ratios facilitates adhesion of the reflective particles within the composition. In further embodiments, the composition comprises a ratio between 1:7 and 1:9 of the synthetic polymer relative to the modeling compound. These examples of ratios, for example, between 1:6 and 1:20 is such that the adhesion of the overall composition is balanced, allowing the composition to adhere to any number of surfaces but allowing easy removal of the composition after application. As such, the composition has a greater self-adhesion strength relative to the strength of adhesion of the composition to other surfaces.

Continuing, the ratio of the percent by weight of the synthetic polymer relative to the percent by weight of the modeling compound prevents or reduces fall-out of the reflective particles from the composition, while the percentage by weight of the reflective particles in the composition gives the composition the appearance of pure glitter without the mess associated with glitter. In one embodiment, the composition comprises from about 1 to about 10 percent, by weight, synthetic polymer, from about 5 to about 40 percent, by weight, modeling compound, and at least about 8 percent, by weight, of reflective particles. In another embodiment, the composition comprises from about 2 to about 4.5 percent, by weight, synthetic polymer, from about 17 to 21 percent, by weight, modeling compound, and at least about 15 percent, by weight, of reflective particles. The ratio of each of the synthetic polymer, modeling compound, and the reflective particles to one another generate these unexpected concurrent qualities of buildable dough-like consistency, the appearance of pure glitter in application, and reduced or prevented reflective particle fall-out from the composition for a mess-free play pattern.

Moreover, because the composition has a dough-like consistency based on the ratios discussed above, the composition may be shaped in any way. Further, because of the self-adhesion of the composition, the composition may be apportioned into one or more defined volumes (e.g., portions or aliquots). For example, the composition may be apportioned into discrete volumes and shaped into spherical forms (e.g., a ball-like shape or “dot” as shown in the example of FIG. 5), elliptical forms, rectangular forms, cylindrical forms (e.g., a cylindrical shape or “snake”), or any polygon. Apportioning the composition allows for discrete quantities of the composition to be “used” by applying one discrete spherical volume of the composition to a surface of an object in a controlled and rationed manner.

Additionally, in some embodiments, the composition comprises a cross-linking agent (e.g., boron-containing salt, boric acid, sodium borate). Examples of additional components include pigments and dyes for color changes such as leuco-dyes (i.e., light responsive color change, thermally responsive color change), compounds for transferring color from the composition to another surface or medium, and/or compounds that aid in the suspension of the reflective particles within the composition. In some embodiments, the composition includes one or more pigments to increase the opacity of the composition and provide a visible color, tint, or shade to the overall composition.

In one embodiment, the composition comprises from about 1 to about 10 percent by weight synthetic polymer, from about 5 to about 40 percent by weight modeling compound, at least about 8 percent by weight of reflective particles, and a cross-linking agent. In one embodiment, the composition comprises a range of about 0.20 to 0.10 percent by weight of a cross-linking agent, with “about” in this instance referring to approximately ±0.05%. The inclusion of a cross-linking agent in the composition can reduce or mitigate the adhesion strength produced by the synthetic polymer, for example. As such, the cross-linking agent can be included in the composition to balance the adhesion of the overall composition in a manner that retains the reflective particles within the composition but which concurrently allows the composition to be applied, removed, and re-applied to an object multiple times without damaging a surface. Examples of cross-linking agents include compounds that comprise boron, boric acid, and/or boron-containing salts.

In embodiments, the composition may include one or more weak acids, wherein the weak acids are used to adjust the pH of the overall composition. Examples of a weak acid include phosphoric acid and citric acid. Adjusting the pH of the overall composition to a range between 4 to 6 using one or more weak acids balances the adhesion of the overall composition in a manner that retains the reflective particles within the composition but which concurrently allows the composition to be applied, removed, and re-applied to an object multiple times without damaging a surface of that object. Additionally, using a weak acid to create the pH value range, discussed above, within the composition prevents the composition from becoming overly-sticky (e.g., adhesion to surfaces is greater than self-adhesion of the composition).

As discussed above, the ranges of the components in the composition provide the composition with superior shaping, molding, and spreading quality. The ranges of the components in the composition also provide the composition with the appearance of pure glitter, while providing containment of the reflective particles within the composition to reduce fall-out.

It will be understood that the composition is not limited to only those chemical compounds described herein, as other chemical compounds that provide the benefits discussed above are considered to be within the scope of the disclosure.

### System for Delivery of the Composition

A system is described hereinafter for delivery of the composition. In embodiments, the system comprises the composition and a tool comprising a body for manipulation or “delivery” of the composition. Generally, the tool may be configured to apply force or pressure to the composition, for example, as apportioned into one or more defined volumes having any shape as discussed above. In some embodiments, the tool is configured to apply force or pressure to the composition so that the composition is deformed. By deforming the composition, the composition may be shaped. Additionally or alternatively, by applying force and deforming the composition, the composition may be forced into contact with a surface or object so that the composition adheres to the surface or object as deformed. By delivering the composition to adhere to a surface or object, the surface or object appears to be coated in pure glitter in those areas where the composition is placed, based on the visibility of the composition.

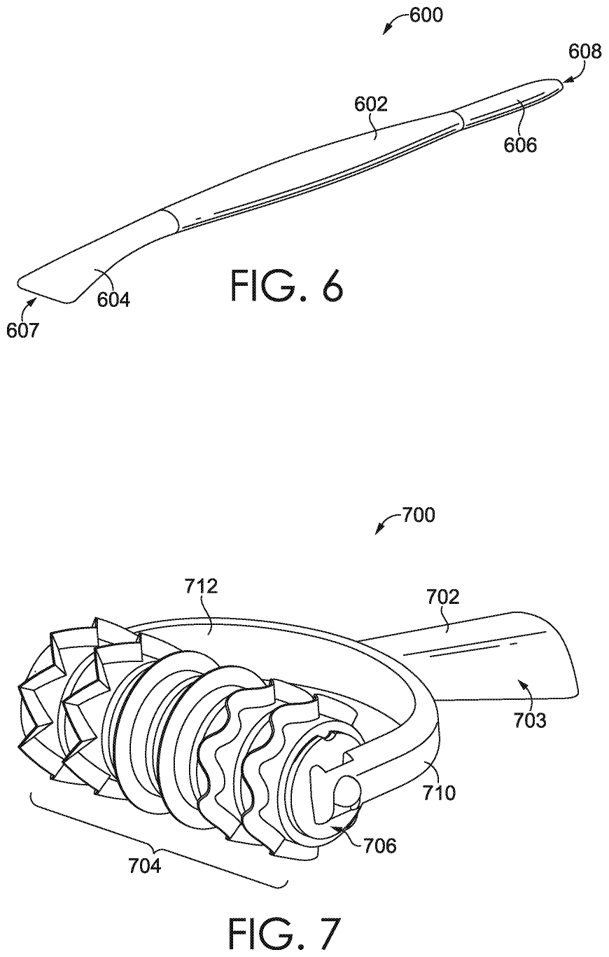

The tool may be used to deform the composition by deforming the composition in a manner that increases the available surface area of a volume of the composition, e.g., by spreading or rolling a defined volume of the composition into a flattened shape or sheet. The tool may be used to apply an amount of pressure over a surface area that is sufficient to deform the composition by cutting, slicing, and/or piercing at least a portion of a defined volume of composition. As such, the tool may comprise at least one of a rounded edge, a beveled edge, a ridge, a blunt end, a projection, a probe, or at least one terminal end that is adapted to slice, cut, poke, or pierce the composition. In the example shown in FIG. 6, the tool 600 comprises a tool body 602. The tool 600 may comprise a first area 604 having a greater width than a second area 606 of the tool body 602, wherein the first area 604 having a greater width than the second area 606 forms a first terminal end 607 of the tool body 602, and wherein the first area 604 is adapted to contact the composition such that when applying force via the tool 600, the first area 604 is adapted to increase the surface area of the composition by spreading at least a portion of the composition, for example, across a surface. In some embodiments, the first terminal end 607 is flared in width and shape (e.g., adapted for spreading) relative to the width of the tool body 602. The first terminal end 607 that is flared may have a width that increases as the first terminal end 607 becomes less proximate the center of the tool body 602 (i.e., in a direction away from the center of the body) and may decrease in width at or near a point or location where the first terminal end 607 is coupled to or merged into the tool body 602. In further embodiments, the tool body 602 of the tool 600 comprises a second terminal end 608 opposite the first terminal end 607, wherein the second terminal end 608 is tapered in shape and in width relative to the width of the tool body 602. In some embodiments, the tool body 602 is a generally cylindrical shape that is from about three to about eight inches in longitudinal length, and having a diameter than is about ¾ to about ½ inch. The surface of one or more areas of the tool body 602 may be textured to increase grip in the hand, or may be smooth to increase comfort in the hand, in some embodiments. Additionally or alternatively, one or more of the first terminal end 607 or the second terminal end 608 may have an area of the surface that is textured (not shown), for example, and adapted to apply force to the composition and thus create patterns or textures in the composition.

In some embodiments, such as that shown in the example of FIG. 7, the tool 700 comprises a tool body 702, and the tool body 702 comprises an handle 703 for positioning in an appendage of a user. In further embodiments, the handle 703 is ergonomically shaped. The tool body 702 may be generally round or cylindrical in shape, in embodiments. In further embodiments, the tool body 702 may be about three to about eight inches in longitudinal length of the cylindrical shape. The tool body 702 may have a diameter that is about ¾ to about ½ inch. The surface of one or more areas of the tool body 702 may be textured to increase grip in the hand, or may be smooth to increase comfort in the hand, in some embodiments. In some embodiments, the tool 700 further includes a cylindrical portion 704 that may be releasably coupled to the body (e.g., can be attached, de-attached, and re-attached multiple times), wherein the cylindrical portion 704 is rotatable in at least one of a clockwise direction or counterclockwise direction about a longitudinal axis that runs parallel to a length of the cylindrical portion 704, and wherein the cylindrical portion 704 is adapted to deform a defined volume of the composition by contacting a surface of the cylindrical portion 704 to the composition and concurrently applying force to the tool 700 in order to rotate the cylindrical portion 704. The cylindrical portion 704 may have a first end 706 and a second end (not visible in FIG. 7) that are configured to mate with a first arm 710 and a second arm 712 of the tool body 702. Mating the first arm 710 of the tool body 702 to the first end 706 of the cylindrical portion 704 and mating the second arm 712 of the tool body 702 to the second end of the cylindrical portion 704 may releaseably affix the cylindrical portion 704 to the tool body 702. As affixed to the tool body 702, the cylindrical portion 704 is able to freely rotate about the longitudinal axis that is parallel to the length of the cylindrical portion 704. In this way, the tool 700 may be used to place the cylindrical portion 704 in contact with a defined or discrete volume of the composition, downward pressure may be applied using the tool body 702, and a forward and back motion may be used with the downward pressure to roll the cylindrical portion 704 over the composition. Accordingly, the tool 700 may be used to roll out or spread the defined or discrete volume of the composition over one or more surfaces, for example. For example, the tool 700 may be a brayer that is adapted to apply the composition to one or more objects, such as a planar product.

### Container for the Composition

Because the composition has a dough-like consistency that can be deformed by the application of force or pressure, for example, via a user's fingers or a tool as discussed above, defined or discrete volumes of the composition that are shaped into a desired form (e.g., as shown in FIG. 5) may lose their desired form when the defined volumes are inadvertently crushed. Accordingly, a container for storing the defined volumes of the composition in a manner that preserves and protects the desired form or shape of the defined volumes is discussed herein.

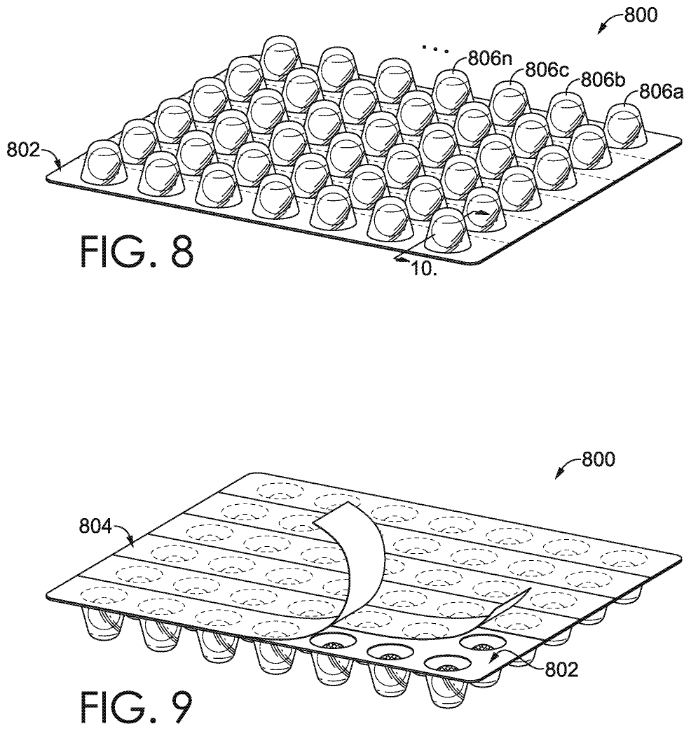

FIGS. 8-9 depict an example container 800 for storing a plurality of discrete volumes of the composition and for protecting the shape or form of the discrete volumes. The container 800 comprises a body 802 and a backing substrate 804. The body 802 comprises a plurality of wells 806a, 806b, 806c, and 806n. Generally, the plurality of wells 806a, 806b, 806c, and 806n extend outward from a plane corresponding to the body 802. In some embodiments, the plurality of wells 806a, 806b, 806c, and 806n are arranged in one or more columns and/or one or more rows. In further embodiments, the plurality of wells 806a, 806b, 806c, and 806n are arranged in and form a plurality of columns and a plurality of rows.

The wells 806a, 806b, 806c, and 806n may be integrally formed with the body 802 such that the body 802 is one unitary piece of construction, in some embodiments. Alternatively, the plurality of wells 806a, 806b, 806c, and 806n may be formed separate from the body 802.

In embodiments, each of the plurality of wells forms a hollow truncated cone shape. In some embodiments, the wells are partially hollow. Each of the plurality of wells 806a, 806b, 806c, and 806n may have dimensions for the truncated cone shape that enable one defined volume of the composition, as shaped into a desired form, to fit within each individual well. In an alternative embodiment, each of the plurality of wells 806a, 806b, 806c, and 806n may have dimensions that enable two defined volumes of the composition, as shaped into the desired form, to fit within each individual well. In yet another embodiment, each of the plurality of wells 806a, 806b, 806c, and 806n may have dimensions that enable one or more defined volumes of the composition, as shaped into a desired form, to physically fit within each individual well. The dimensions of each of the plurality of wells 806a, 806b, 806c, and 806n prevents crushing of the individual wells, and by proxy, crushing of the defined volumes of the composition stored in each well. In particular, the dimensions of the truncated cone shape with a rounded distal portion may prevent crushing of the wells, thus protecting any stored composition.

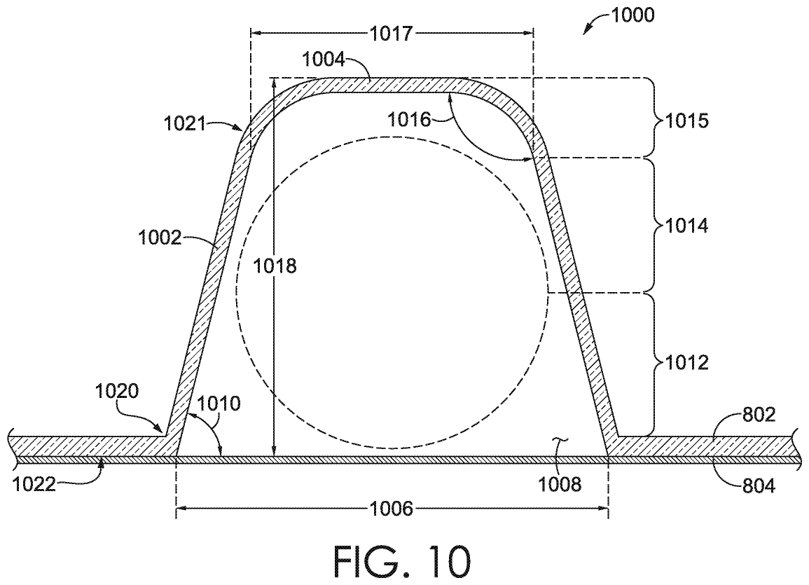

Turning to FIG. 10, an example of a well 1000 is depicted, shown in a cross section taken perpendicular to the plane of the body 802 in the orientation shown in FIG. 9. The well 1000 is integrally formed with the body 802. The well 1000 generally exhibits a cross-sectional shape of a generally hollow truncated cone, such that the well forms a hollow 1008 having an opening at the base of the truncated cone shape that, thus, is an opening that provides access to the hollow 1008. The well 1000 comprises a first wall 1002 and a second wall 1004. The first wall 1002 may be about 10 to 15 millimeters in length, in some embodiments. Additionally, the first wall 1002 may have a material thickness of about 0.6 to about 0.2 millimeters, in various embodiments. In other embodiments, the first wall 1002 may have a materials thickness between about 1 to about 0.6 millimeters. The material thickness of the first wall 1002 may not be uniform, in some embodiments. The first wall 1002 and the second wall 1004 may have the same or different material thickness, in various embodiments.

The first wall 1002 forms a conical shape having a first diameter 1006, where the first diameter 1006 is measured where the first wall 1002 adjoins the body 802. In embodiments, the opening of the well may have a first diameter 1006 measuring about 10 to about 16 millimeters. The first diameter 1006 corresponds to a first base of the truncated cone shape. Notably, the first base of the well 1000 corresponds to the opening that provides access to the hollow 1008 of the well 1000. As such, a defined volume of composition may be inserted into the well 1000 using the opening and placed into the hollow 1008 for storage. Accordingly, the volume of the cavity is greater than the defined volume of the composition.

As the well 1000 is shaped as a hollow truncated cone in some embodiments, the first wall 1002 extends away from the body 802 and extends out of the plane of the body 802 at an acute angle 1010. The acute angle 1010 may be about 63 to about 85 degrees, in some embodiments. In further embodiments, the acute angle 1010 may be about 75 to about 80 degrees. The first wall 1002 has a first proximate portion 1012 that is nearer the body 802 and a second distal portion 1014 that is nearer or abuts the second wall 1004 of the well 1000. The second distal portion 1014 of the first wall 1002 adjoins the second wall 1004 of the well 1000. The first wall 1002 and the second wall 1004 form an obtuse angle 1016, the obtuse angle 1016 being measured from within the hollow 1008. The obtuse angle 1016 may be about 95 to about 125 degrees. In one embodiment, the obtuse angle 1016 may be about 100 to about 105 degrees.

Generally, the second wall 1004 corresponds to a second base of the truncated cone shape. In simpler terms, the second wall 1004 corresponds to the “bottom” of the well or the narrower “top” end of the truncated cone shape. In some embodiments, a location where the first wall 1002 adjoins the second wall 1004, a second wall rounded portion 1021 is formed. The second wall 1004 and the second wall rounded portion 1021 together form a rounded distal portion 1015 of the hollow truncated cone shape, as further discussed hereinafter. As the second wall 1004 forms a rounded distal portion 1015 of the truncated cone shape, this portion of the truncated cone shape is measurable as having a second diameter 1017. Accordingly, the second diameter 1017 corresponds to a diameter of the second wall 1004. The second wall 1004 may have a second diameter 1017 of about 5 to about 12 millimeters, in embodiments. Additionally, the second wall 1004 may have a material thickness of about 0.6 to about 0.2 millimeters. The material thickness of the second wall 1004 may not be uniform, in some embodiments. In embodiments, the second diameter 1017 of the truncated cone shape is less than the first diameter 1006 of the first base of the truncated cone shape of the well 1000. Because the second diameter 1017 is smaller than the first diameter 1006 based on the first wall 1002 extending outward from the body 802 at the acute angle 1010, the well 1000 is crush-resistant, for example, when force is applied to the second wall 1004 in a direction inward and toward the plane of the body 802. Therefore, one or more discrete volumes of composition having a desired shape or form that is/are stowed within the well 1000 can maintain their desired shape or form when force is applied to the second wall 1004 in a direction inward and toward the plane of the body 802 because the second wall 1004 is prevented from moving inward to contact the discrete volume(s) stowed in the well 1000.

Thus, in some embodiments, the first wall 1002 forming the hollow truncated shape has a first diameter 1006 measured proximate to the body 802 and the rounded distal portion 1015 formed by the second wall 1004 has a second diameter 1017, wherein the first diameter is greater than the second diameter of the second wall due to the cone shape of the well 1000. In one embodiment, the second diameter is about ¾ relative to the first diameter. In another embodiment, the second diameter is about ½ relative to the first diameter. In yet another embodiment, the second diameter is about ¼ relative to the first diameter. The ratio of the second diameter 1017 relative to the first diameter 1006 provides structural strength against crushing the hollow truncated cone shape of the well 1000 inward toward the plane of the body 802.

Further, the second wall rounded portion 1021, located wherein the first wall 1002 abuts or meets the second wall 1004 to form a round edge, aids in the distribution of stress when force is applied to the second wall 1004 in a direction inward and toward the plane of the body 802, further bolstering the crush-resistance of the well 1000, in some embodiments. The second wall rounded portion 1021 provides at least a partially domed appearance of the second wall 1004 for the truncated cone shape, in embodiments. In further embodiments, the second wall rounded portion 1021 provides a partially domed appearance to the truncated cone shape, while at least a portion of the second wall 1004 remains planar and substantially parallel to the plane of the body 802.

Continuing, the first wall 1002 extends a first distance 1018 from the plane of the body 802. The first distance 1018 may be between 9 and 14 millimeters, in embodiments. The first distance 1018 may contribute to the crush-resistance of the well 1000. For example, when force is applied to the second wall 1004 in a direction inward and toward the plane of the body 802, the force is distributed as a stress against the first wall 1002 along the first distance 1018, from the second distal portion 1014 of the first wall 1002 to the first proximate portion 1012 of the first wall 1002, to the first wall portion 1020 of the first proximate portion 1012 with the body 802. In some embodiments, the first wall portion 1020 corresponds to the circumference of the first base of the truncated cone shape of the well. Although shown otherwise, the first wall portion 1020 may be a round edge that blends the first proximate portion 1012 into the plane of the body 802, in some embodiments. A rounded edge of the first wall portion 1020 may provide additional strength to the well 1000, in such embodiments.

The height of the truncated cone, i.e., the depth of the well 1000, is measured from the first base to the second base, i.e., is a distance from the second wall 1004 to the plane of the body 802 measured at a right angle to the plane of the body 802 and at a right angle to the second wall 1004. The height of the truncated cone is such that a discrete volume of the composition may fit into the hollow 1008 of the well 1000 and be stored between the second wall 1004 and the backing substrate 804. Turning again to FIG. 10, the backing substrate 804 may be configured to adhere to a first surface 1022 of the body 802. By adhering to the first surface 1022, the backing substrate 804 seals one or more hollows (e.g., hollow 1008 of well 1000) of the plurality of wells 806a, 806b, 806c, and 806n. As such, discrete volumes of composition may be placed in the hollows of the one or more of the plurality of wells 806a, 806b, 806c, and sealed within the plurality of wells 806a, 806b, 806c, and 806n by placement of the backing substrate 804 that is adhered to the first surface 1022 of the body 802, in embodiments. Examples of materials that may be used to construct or form any and all portions of the body 802 include one or more thermoplastics. Examples of thermoplastics includes polyethylene terephthalate and poly ethylene. The backing substrate 804 may comprise a tear-resistant materials that forms, as adhered to the first surface 1022 using adhesive and/or heat, an air-tight seal (i.e., hermetic seal) of one or more discrete volumes of composition stored within the plurality of wells 806a, 806b, 806c, and 806n. The backing substrate 804 may have a material thickness that is about less than 1 millimeter, in some embodiments. Additionally, in some embodiments, the backing substrate 804 is constructed from a non-permeable material that seals each of the plurality of wells to reduce moisture loss from a discrete volume of the composition stored in the hollow truncated cone shape. In one embodiment, the backing substrate 804 comprises an aluminum-based material. In another embodiment, the backing substrate 804 comprises a combination of thermoplastics, such as polyethylene terephthalate and poly ethylene, and an aluminum containing foil.

The hermetic seal may preserve the dough-like consistency of the composition stored therein by limiting the volume of air in contact with the composition. By limiting the volume of air in contact or in circulation of the stored composition, the moisture content of the composition may be preserved and/or moisture loss may be reduced or minimized, which thus preserves the dough-like consistency of the composition. In some embodiments, the backing substrate 804 is arranged to seal the plurality of wells 806a, 806b, 806c, and 806n in distinct rows or columns. Thus, the backing substrate 804 may be arranged in one or more strips that correspond to the one or more columns of the plurality of wells 806a, 806b, 806c, and 806n, in various embodiments. In further embodiments, the backing substrate 804 may be arranged in a plurality of strips that correspond to a plurality of columns of the wells. Each strip, for example, may be individually separable from the body 802 and/or the first surface 1022 of the body 802. The backing substrate 804 may include perforations or cuts that separate the backing substrate 804 into one or more strips. The perforations may enable each strip to be individually peeled away from the body 802 in order to open each well arranged in one column, one well at a time, for example. As such, the backing substrate 804 may be pulled or peeled away from the first surface 1022 of the body 802 in order to access the composition stowed within each of the wells. In embodiments, the backing substrate 804 is configured to allow controlled, rationed access to each well and composition stored therein.

Accordingly, the crush-resistance of each of the plurality of wells 806a, 806b, 806c, and 806n of the container 800 preserves the desired shape of the discrete volume of the composition stored therein, the backing substrate 804 of the container 800 preserves the dough-like discrete volume of the composition stored therein, and the arrangement of the backing substrate 804 which facilitates a one-at-a-time opening of each of the plurality of wells 806a, 806b, 806c, and 806n, which rations access to the discrete volumes of the composition, such that the discrete volumes of the composition are used as-needed.

Additionally or alternatively, a plurality of segments of the discrete volumes of the composition may be stored within the plurality wells 806a, 806b, 806c, and 806n of the container 800. As such, the plurality of segments comprise the composition, which includes a plurality of glitter particles, in some embodiments. The plurality of segments may be removeably stored within the plurality wells 806a, 806b, 806c, and 806n based on selective removal of the backing substrate 804, which may be perforated to aid in removing the backing substrate 804 in strips.

It will be understood that the shapes and dimensions described regarding the container are not limited to only those shapes and dimensions described herein, as other shapes and dimensions that provide crush-resistance to the wells are considered to be within the scope of the disclosure. Any materials having sufficient rigidity may be used in the construction of the wells of the containers, and any material providing a hermetic seal may be used as the backing substrate 804.

### Kits Including the Composition

Embodiments herein include a kit comprising the composition discussed above. In some embodiments, the kit comprising the composition includes one or more containers as discussed above, storing defined or discrete volumes of the composition. In some embodiments, the kit comprises the composition, the container for the composition, and one or more tools for delivery of the composition. In yet another embodiment, the kit comprises the composition, the container for the composition, one or more tools for delivery of the composition, and at least one object to which the composition is configured to adhere. In some embodiments, the kit includes the composition as apportioned into at least two defined volumes, each volume having a different color. In further embodiments, the kit includes the composition as apportioned into a plurality of defined volumes having a plurality of different colors of composition and/or reflective particles.

Continuing, in some embodiments, the kit may comprise the composition and an object. The object may comprise one or more exposed or accessible surfaces to which the composition is formulated to adhere, in embodiments. In one embodiment, the object comprises one or more exposed or accessible surfaces to which the composition may be applied using force to place the composition in contact with the object. Exemplary objects may be constructed from one or more of paper fibers, paperboard, foam, foamboard, plastics, vinyl, acrylic, wood fibers, wood, metals, glass, ceramics, porcelain, concrete, stone, and/or clay. In one example, the kit may include a variety of different objects and/or surfaces to which the composition is formulated to adhere.

The object may have one or more surface areas that are smooth, ridged, textured, opaque, transparent, semi-transparent, colored, and/or tinted, in various embodiments. The object may have one or more surface areas that include visible ridges, printed lines, and/or depressions that, for example, may serve as guides for the application of one or more discrete volumes of composition. The object and/or one or more surfaces of the object may be adapted to facilitate both application and removal of the composition after application, for example, in a manner that the self-adhesion of the composition is maintained to be greater than the adhesion of the composition to the object. Thus, the object may be reusable in some embodiments, such that the composition may be applied, removed, and re-applied to the object, for example. This allows a person, for example, to apply a discrete volume of the composition in a first color to a first area, remove that volume of composition, and instead apply another discrete volume of the composition in a second different color to the first area (i.e., removability allows a user of the kit to try different color combinations and placements of the composition to the object for artistic expression).

In an embodiment, one or more areas on a surface of the object have one or more ridges. The composition may be applied to between one or more ridges in order to fill or “flood” those areas of the surface of the object between or within ridge(s), for example, with the composition so that those areas appear to be pure glitter. In some embodiments, the surface of the object has one or more depressions, divots, and/or grooves. One or more discrete volumes of the composition may be applied to partially or completely fill those depressions, divots, and/or grooves with the composition so that those areas have the appearance of pure glitter. In an embodiment, the surface of the object includes one or more of a ridge, groove, divot, depression, pattern, printed lines, or texture that form one or more of a shape, letter, number, face, animal, or design element. In another embodiment, the object is a three-dimensional shape.

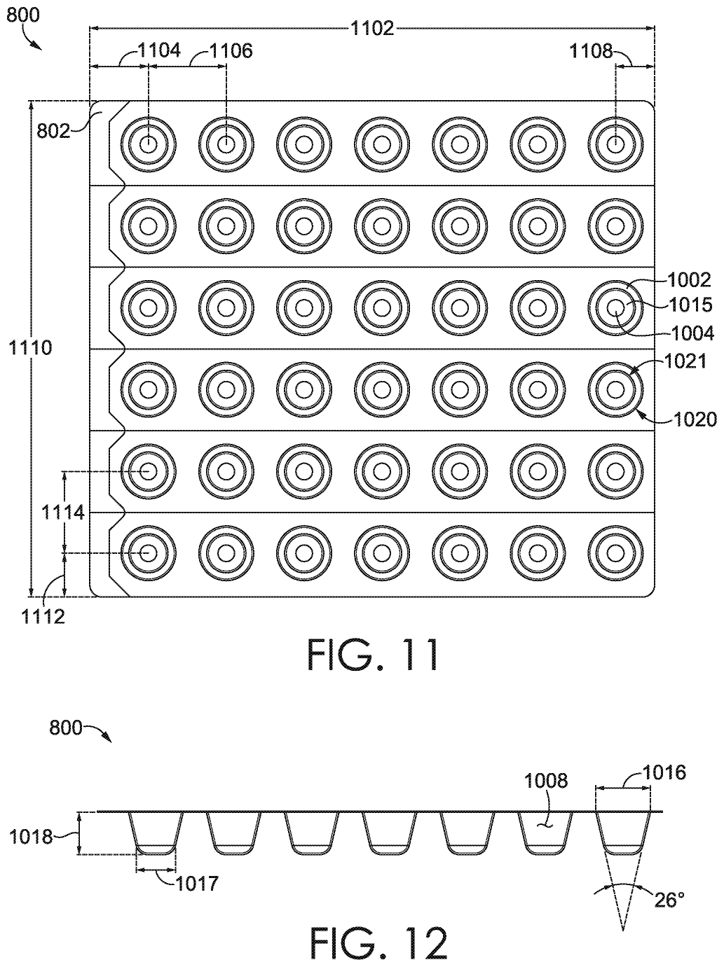

FIG. 11 depicts a bottom-up view of the body 802 of FIG. 9. In embodiments, the overall length 1102 of the body is about 100 to about 200 millimeters. Each of the plurality of wells 806a, 806b, 806c, and 806n may be evenly spaced apart along the overall length 1102, in some embodiments, such that each well is the same distance from one another along the overall length 1102 of the body 802. Alternatively, each of the plurality of wells 806a, 806b, 806c, and 806n may be unevenly spaced with respect to the overall length 1102. In an embodiment, each of the plurality of wells 806a, 806b, 806c, and 806n are spaced about 20 millimeters apart, wherein this distance 1106 is measured from the center of one of the wells to the center of another of the wells. Additionally or alternatively, a terminal well in a row or column may be located about 20 millimeters or less from an edge of the body 802. For example, one terminal well may be located at a distance 1104 of about 15 millimeters from one edge of the body 802 and another terminal well may be located at a distance 1108 of about 10 millimeters from the edge of the body 802. These distances may be measured from the center of each well, generally.

The overall width 1110 of the body 802 may be about 100 to about 150 millimeters, in some embodiments. Each of the plurality of wells 806a, 806b, 806c, and 806n may be evenly spaced apart along the overall width 1110, in some embodiments, such that each well is the same distance from one another along the overall width 1110 of the body 802. Alternatively, each of the plurality of wells 806a, 806b, 806c, and 806n may be unevenly spaced with respect to the overall width 1110. In an embodiment, each of the plurality of wells 806a, 806b, 806c, and 806n are spaced about 20 to about 25 millimeters apart, wherein this spacing distance 1114 is measured from the center of one of the wells to the center of another of the wells. Additionally or alternatively, a terminal well in a row or column may be located about 10 to about 15 millimeters or less from an edge of the body 802. For example, one terminal well may be located at a distance 1112 of about 12 millimeters from one edge of the body 802. The distance may be measured from the center of each well, generally.

In various embodiments, the spacing of the wells with respect to the overall width 1110 is the same as the spacing of the wells with respect to the overall length 1102. Alternatively, the spacing of the wells with respect to the overall width 1110 is different from the spacing of the wells with respect to the overall length 1102, in one embodiment.

FIG. 12 depicts a cross-sectional view of the body 802 of FIG. 9. As shown in the cross-sectional view, each well may have an intersection angle of about 30 to about 20 degrees. In another embodiment, each well may have an intersection angle of about 28 to about 24 degrees. In one embodiment, the intersection angle is about 26 degrees. The intersection angle generally refers to an interior angle that is measured at the apex of a non-truncated cone shape that is extrapolated from the truncated cone shape, as shown in the example of FIG. 12. As such, where the wells to lack a second wall and the first wall were to extend fully to create a non-truncated cone shape, the interior angle would be measured where the first wall forms the apex of the non-truncated cone shape.

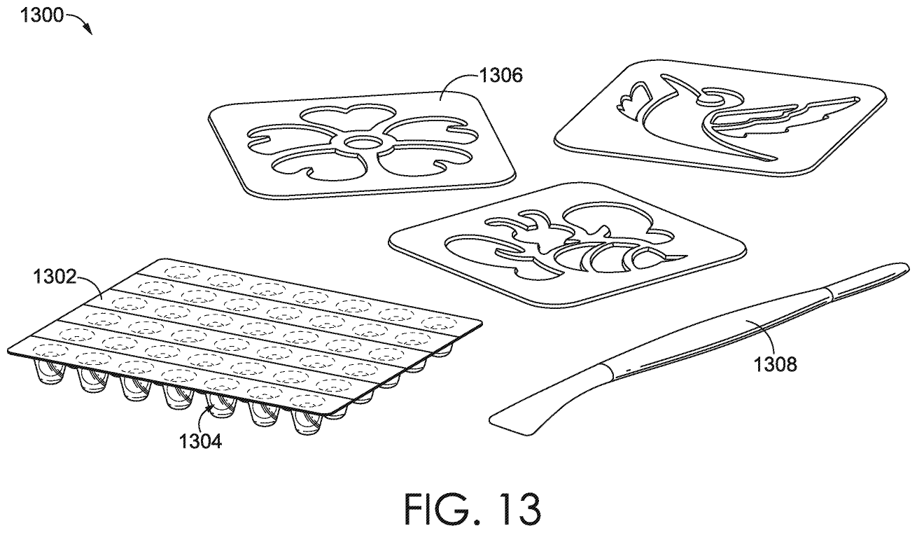

FIG. 13 depicts an example of a kit 1300. The kit 1300 comprises a container 1302 storing a plurality of defined volumes 1304 of the composition sealed in the container by a backing substrate. The kit 1300 further comprises one or more objects 1306, which include stencils, in such an embodiment. Additionally, the kit 1300 of FIG. 13 comprises a tool 1308 configured to apply the composition to a surface (not shown). For example, a user may place a stencil on top of a substrate or surface. The stencil may comprise at least one surface area that is adapted to inhibit adherence of the composition to the stencil, for example. Additionally, the stencil further comprises one or more openings that are adapted to allow adherence of the composition to the underlying substrate through those openings. As such, subsequent to placing or overlaying the stencil onto the substrate or surface, a user may place one or more defined volumes 1304 of the composition into the openings of the stencil, and apply force to the one or more defined volumes to spread the composition into the openings using the tool 1308, filling the shape of the openings and placing the composition in contact with the underlying surface. Then, the one or more objects 1306 may be lifted, leaving behind the portions of the composition that were applied to the surface using the tool 1308. The portions of the composition applied to the surface correspond in size and shape to the size and shape of the openings in the one or more objects 1306 that is a stencil.

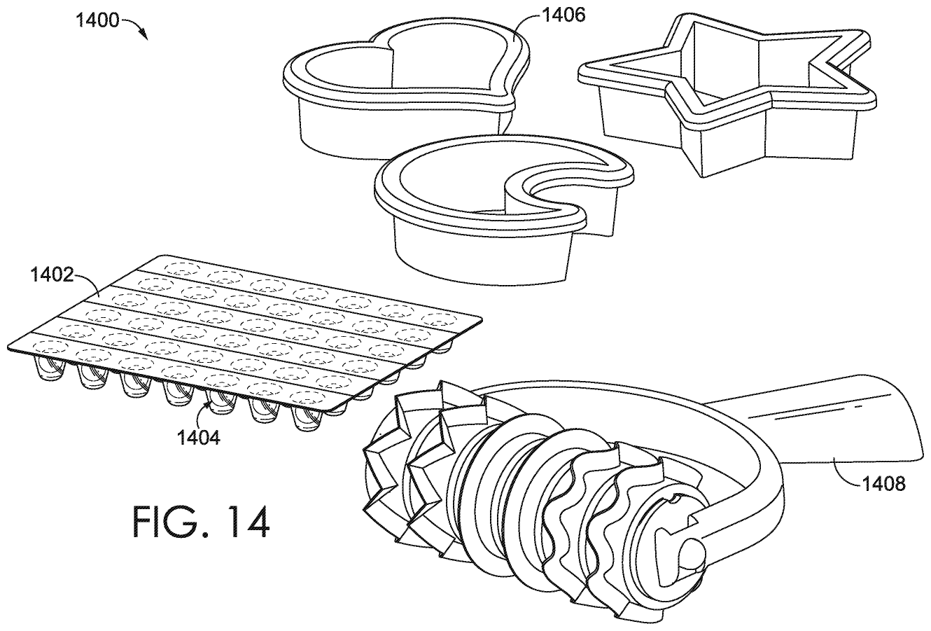

FIG. 14 depicts another example of a kit 1400. The kit 1400 comprises a container 1402 storing plurality of defined volumes 1404 of the composition sealed in the container by a backing substrate. The kit 1400 further comprises one or more objects 1406. The one or more objects 1406 may be objects that are configured to cut through the composition when the composition is deformed and spread out into a sheet-like state, in such an embodiment. Additionally, the kit 1400 of FIG. 14 comprises a tool 1408 configured to apply the composition to a surface (not shown). For example, a user may spread one or more segments of defined volumes (after opening one or more wells of the container 1402 to retrieve the composition) of the composition over a flat surface to create a substantially planar layer of composition. The user may then use the one or more objects 1406 to cut the planar layer of composition into shapes that correspond to the shape of the objects 1406. The tool 1408 may be used to press designs or cut into the substantially planar layer of composition. These designed portions of compositions or cut-outs of composition may then be adhered to any surface or object, in various embodiments. The cut-outs of the composition provide the appearance of pure glitter.

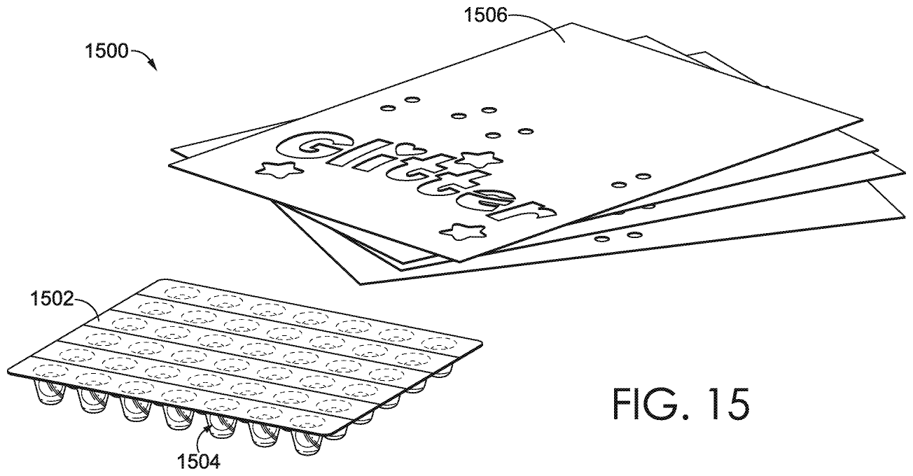

FIG. 15 depicts yet another example of a kit 1500. The kit 1500 comprises a container 1502 storing plurality of defined volumes 1504 of the composition sealed in the container by a backing substrate. The kit 1500 further comprises one or more objects 1506 to which the composition may be adhered. The one or more objects 1506 may comprise a paper product, in some embodiments. In another embodiment, the one or more objects 1506 may comprise a planar product. Examples of planar products may be constructed from any material, such as paper or paper fibers. The one or more objects 1506 may include lines that create an application guide for a visual design, in some embodiments. As such, a user may apply one or more segments of defined volumes of the composition directly to the one or more objects 1506 in order to add the appearance of pure glitter to one or more portions of the visual design, for example, using the application guide created by the lines.

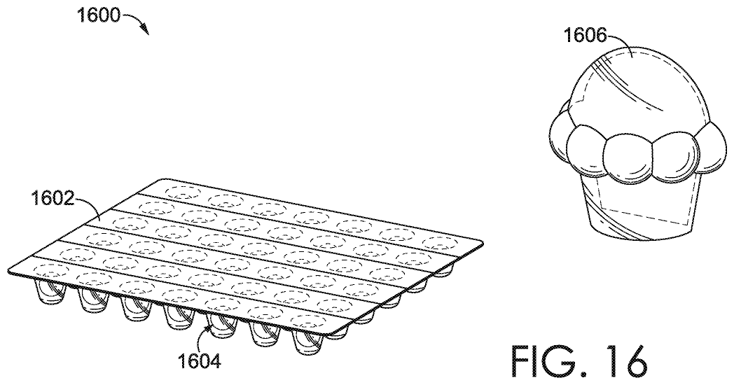

FIG. 16 depicts yet another example of a kit 1600. The kit 1600 comprises a container 1602 storing plurality of defined volumes 1604 of the composition sealed in the container by a backing substrate. The kit 1600 further comprises one or more objects 1606 to which the composition may be adhered. The one or more objects 1606 may comprise a two-dimensional and/or three-dimensional surface object. In one embodiment, the one or more objects 1606 are three-dimensional, having an exterior surface and an interior surface. The one or more objects 1606 may be adapted to receive the composition applied to one or more of the exterior surface and/or interior surface, in some embodiments. In further embodiments, the one or more objects 1606 may comprise a transparent and/or semi-transparent material, for example. The composition may be applied to the one or more objects 1606 using force or pressure. Accordingly, in some embodiments, the composition is applied to an interior surface of a transparent or semi-transparent object so that the composition is visible through the object. This gives the object the appearance of being filled with reflective particles, for example. Notably, the reflective particles remain within the composition such that the reflective particles are not free or loose.

In yet another embodiment involving a transparent three-dimensional surface forming an interior of a part or a hollow mold, the composition may be applied using a tool, or even injected using a syringe-like device to force the composition into an interior cavity of an object. For example, in an embodiment where the object is three-dimensional and has a first exterior layer and a second interior layer, and where the first exterior layer is at least partially spaced apart from the second interior layer to form a cavity between the first exterior layer and the second interior layer, the object may be adapted to receive the composition in the cavity formed between the first exterior layer and the second interior layer. Of the one or more objects described herein, the object(s) may further comprises a hanging mechanism, such that the object(s) may be displayed after the application of the composition, for example.

Additionally or alternatively, the composition may be deposited onto a surface or object in a free form manner by applying the composition to the surface or object, and applying pressure to the composition as applied to the surface or object. The composition shapes may be applied to various surfaces to provide the look of a surface that is substantially or completely covered with reflective particles.

In further embodiments, the kit may comprise a tool configured to emboss or carve a surface of an object in the kit. The object may have one or more surface areas lacking ridges or grooves wherein the tool can be used to apply pressure to emboss (e.g., crush material) or carve (e.g., remove material) the surface of the object. In one such embodiment, the ridges and/or grooves created using the tool can be filled with glitter. Additionally, the tool may create ridges or grooves that are specifically shaped to fit the dimensions of an applicator that is adapted to apply or deliver the composition. An applicator for depositing the composition may be shaped to fit between ridges, against ridges, and/or may fit into grooves such that the composition may be deposited with control and finesse.

Although the kits described herein are depicted as comprising the container for storing discrete volumes of the composition, it will be understood that other container(s) may be employed or altogether omitted from a kit. As such, embodiments of the kits discussed herein that omit the container discussed hereinabove are contemplated to be within the scope of this disclosure.

The present invention has been described in relation to some embodiments, which are intended in all respects to be illustrative rather than restrictive. Further, the present invention is not limited to these embodiments, but variations and modifications may be made without departing from the scope of the present invention.

What is claimed is:

1. A composition comprising:
from about 1 to about 10 percent, by weight, synthetic polymer;
from about 5 to about 40 percent, by weight, modeling compound; and
at least about 8 percent, by weight, of reflective particles.

2. The composition of claim 1, wherein the synthetic polymer is polyvinyl alcohol or polyvinyl acetate.

3. The composition of claim 1, wherein the modeling compound comprises starch.

4. The composition of claim 1, wherein the composition comprises a ratio between 1:6 and 1:40 of the synthetic polymer relative to the modeling compound.

5. The composition of claim 1, comprising from about 1 to about 5 percent, by weight, the synthetic polymer and from about 15 to about 30 percent, by weight, the modeling compound.

6. The composition of claim 1, comprising from about 3 to about 4 percent, by weight, the synthetic polymer and from about 17 to about 22 percent, by weight, the modeling compound.

7. The composition of claim 1, comprising about 15 to about 35 percent, by weight, the reflective particles.

8. The composition of claim 1, comprising about 16 to about 22 percent, by weight, the reflective particles.

9. The composition of claim 1, further comprising from about 0.1 to about 0.2 percent, by weight, of a cross-linking agent.

10. A kit comprising:
a composition comprising from about 1 to about 10 percent, by weight, synthetic polymer, from about 5 to about 40 percent, by weight, modeling compound, and at least about 10 percent, by weight, of reflective particles; and
an object, wherein the composition is formulated to adhere to the object.

11. The kit of claim 10, wherein the object comprises a planar product.

12. The kit of claim 10, wherein the object comprises a substrate and a stencil adapted to overlay the substrate, the stencil having one or more surface areas adapted to inhibit adherence of the composition to the stencil.

13. The kit of claim 12, wherein the stencil further comprises one or more openings, wherein the one or more openings are adapted to facilitate contact of the composition to the substrate through the one or more openings in the stencil when overlaying the substrate.

14. The kit of claim 10, wherein the object is three-dimensional and has an exterior surface and an interior surface, and wherein the object is adapted to receive the composition at one or more of the exterior surface or the interior surface.

15. The kit of claim 10, wherein the object is three-dimensional and has a first exterior layer and a second interior layer, wherein the first exterior layer is at least partially spaced apart from the second interior layer to form a cavity between the first exterior layer and the second interior layer, and wherein the object is adapted to receive the composition in the cavity formed between the first exterior layer and the second interior layer.

16. The kit of claim 10, wherein the object further comprises a hanging mechanism.

17. A system for delivery of a composition, the system comprising:
a composition comprising a plurality of glitter particles; and
a tool having a body, the tool being adapted to deliver the composition to a surface by applying force via the body to physically deform the composition.

18. The system of claim 17, wherein the tool further comprises a cylindrical portion that is coupled to the body, wherein the cylindrical portion is rotatable in at least one of a clockwise direction or a counterclockwise direction about a longitudinal axis that corresponds to a length of the cylindrical portion, and wherein the cylindrical portion is adapted to contact a defined volume of the composition and rotate to physically deform the defined volume of the composition.

19. The system of claim 17, wherein the tool further comprises at least one exterior surface configured to deform a defined volume of the composition by applying force to at least a portion of the defined volume of the composition that increases a surface area of the defined volume of the composition.
